(19) United States
(12) Patent Application Publication
(10) Pub. No.: US 2005/0069718 A1
(43) Pub. Date: Mar. 31, 2005

(54) Printable insulating compositions and printable articles

(76) Inventors: Jessica L. Voss-Kehl, Inver Grove Heights, MN (US); John T. Brady, White Bear Township, MN (US); D. Scott Thompson, Woodbury, MN (US); Bruce A. Nerad, Oakdale, MN (US); Frank J. Bottari, Acton, MA (US)

Correspondence Address: 3M INNOVATIVE PROPERTIES COMPANY, PO BOX 33427, ST. PAUL, MN, 55133-3427, US

(21) Appl. No.: 10/674,999

(22) Filed: Sep. 30, 2003

(51) Int. Cl. B32B 9/04; C08L 83/04; B41J 2/01

(52) U.S. Cl. 428/447; 524/858; 347/102; 116/205

(57) ABSTRACT

A printable composition for forming an insulating layer is disclosed, the insulating layer typically being a dielectric layer. The printable composition is particularly well suited for making cured insulating layers on touch screens, but is also suitable for a variety of other applications. In certain embodiments the composition is suitable for application using digital printing technology such as ink jet printing to precisely apply the printable composition it to a substrate. In addition, the present invention is directed to insulating layers and made using the composition, as well as to methods of applying the composition and articles incorporating insulating layers made using the composition.

### FIELD OF THE INVENTION

The present invention relates generally to printable insulating materials, including ink jet printable insulating materials for use in touch screen displays, and cured printed insulating materials.

### BACKGROUND

Insulating materials, including dielectric materials, can be patterned onto touch screen displays to form a protective coating or mask over the circuitry of the display. Insulating materials can also be used to electrically isolate conductive features, and can be coated over an entire display for use as a hard coat. These insulating materials are frequently applied by screen-printing a liquid or paste composition that is subsequently cured at elevated temperatures, or by curing with ultraviolet light or a different radiation source. Screen-printing typically requires that a printing screen make contact with the display, which can contaminate and scratch other components of the display. Other disadvantages of screen printing include the need to periodically clean the screen, the need to keep an inventory of screens on hand, and the relatively slow processing time often associated with using a screen-printing process.

Thus, a need exists for improved insulating materials that can be applied to a substrate without screen-printing.

### SUMMARY OF THE INVENTION

A need exists for improved insulating materials; for methods of applying insulating materials, including dielectric materials, to a substrate; and for articles incorporating the improved insulating materials.

The present invention is directed, in part, to a printable composition for forming an insulating layer on a substrate, as well as insulating layers formed from the printable composition. The insulating layer can be, for example, a dielectric layer applied to a substrate that comprises a portion of a touch screen panel. The printable composition generally includes a polymeric component containing both silicon and oxygen atoms. Suitable polymeric components include polyorganosilsesquioxanes, such as polymethylsilsesquioxane, which generally have a 1.5:1 ratio of oxygen to silicon. The printable composition upon coating and curing is generally at least 20 percent by weight polyorganosilsesquioxane (“PSQ”), although certain formulations can have less than 20 percent PSQ. In certain embodiments of the invention the printable composition, upon coating and curing, comprises from 5 to 95 percent by weight polymethylsilsesquioxane and from 5 to 95 percent by weight inorganic nanoparticles. The printable composition is generally cured at an elevated temperature to form a cured insulating material, also referred to herein as a printed insulating material.

In some implementations, inorganic nanoparticles and other ingredients are incorporated into the composition to give it improved physical properties, including improved hardness, desired viscosity and other flow properties, and control of index of refraction. When nanoparticles are incorporated they can include, for example, one or more of silica, zirconia, and alumina particles. In some implementations the nanoparticles have an average size of 1 to 500 nanometers, while in others the nanoparticles have an average size of 5 to 250 nanometers, while in yet other implementations they have an average size of 5 to 125 nanometers. In most implementations at least 1 percent of the printable composition is nanoparticles, and even more typically the amount of nanoparticles is greater than 5 percent of the composition. The nanoparticles are surface-modified in some implementations of the invention.

In one implementation the printable composition has a viscosity making it amenable to application by digital printing techniques such as ink jet printing, thereby allowing very precise placement of the composition without damaging the substrate onto which it is deposited. Viscosities suitable for digital printing techniques can range from 1 to 100,000 centipoise, measured using continuous stress sweep over shear rates of 1 s⁻¹ to 1000 s⁻¹. In order to be ink jet printed, the composition typically has a viscosity greater than 1 centipoise, but usually less than 40 centipoise, measured using continuous stress sweep over shear rates of 1 s⁻¹ to 1000 s⁻¹. In some implementations the composition has a viscosity of 10 to 14 centipoise measured using continuous stress sweep, over shear rates of 1 s⁻¹ to 1000 s⁻¹. In another embodiment, the viscosity can be adjusted to be shear thinning as required for screen printing. In this embodiment, the PSQ nanocomposite provides improved thermal stability over commonly printed insulating materials.

The printable composition is particularly suitable for use on touch activated user input devices. In such implementations the touch activated user input device has a substrate plus an insulating layer deposited onto at least a portion of the substrate, the insulating layer comprising a polysilsesquioxane, and typically also comprising inorganic nanoparticles. Suitable substrates include glass or polyethylene terephthalate (PET). These substrates may also be partially coated with a conductive coating such as conductive oxides or polymers.

The invention is further directed to a method for making a touch activated user input device comprising providing a substrate, printing a composition containing a polysilsesquioxane onto the substrate, and curing the composition to form an insulating layer. This curing step often occurs at, for example, less than 150° C., and frequently less than 200° C. In some implementations the step of printing comprises ink jet printing, while in others the step of printing comprises screen-printing.

Terms used to describe the present invention correspond to the following definitions.

The term “nanoparticle” signifies particles characterized by an average particle diameter in the range of nanometers. In some implementations the nanoparticles have an average size of 1 to 500 nanometers, while in others the nanoparticles have an average size of 5 to 250 nanometers, while in yet other implementations they have an average size of 5 to 125 nanometers, or from 5 to 75 nanometers. Particle size refers to the number average particle size and is measured using an instrument that uses transmission electron microscopy or scanning electron microscopy. Another method to measure particle size is dynamic light scattering, which measures weight average particle size. One example of such an instrument found to be suitable is the N4 PLUS SUB-MICRON PARTICLE ANALYZER available from Beckman Coulter Inc. of Fullerton, Calif.

Terms such as “nanocomposite coating” or “nanocomposite coating dispersions” and the like refer to fluid coating dispersions comprising a fluid dispersion phase containing a dispersed phase including a nanoparticulate powder.

Terms such as “silsesquioxane” or “organosilsesquioxane” or “polyorganosilsesquioxane” or the like refer to the fluid dispersion phase of a nanocomposite coating dispersion. The dispersion phase may include a blend of fluids or added solvent that provides a solution dispersion phase.

Terms such as “conductive polymers” refer to polymers that are electrically conductive. Some examples of conductive polymers are polypyrrole, polyaniline, polyacetylene, polythiophene, polyphenylene vinylene, polyphenylene sulfide, poly p-phenylene, polyheterocycle vinylene, and materials disclosed in European Patent Publication EP-1-172-831-A2, which is hereby incorporated by reference in its entirety.

All percentage, parts and ratios herein are by weight, e.g. weight percent (wt %) unless specifically noted otherwise.

Other features and advantages of the invention will be apparent from the following detailed description of the invention and the claims. The above summary of principles of the disclosure is not intended to describe each illustrated embodiment or every implementation of the present disclosure.

### BRIEF DESCRIPTION OF THE DRAWINGS

The invention may be more completely understood in consideration of the following detailed description of various embodiments of the invention in connection with the accompanying drawings, in which:

FIG. 1 is a simplified side cross-section of a substrate containing an insulating layer constructed and arranged in accordance with an implementation of the invention;

FIG. 2 is a simplified side cross-section of a touch panel display constructed and arranged in accordance with an implementation of the invention;

FIG. 3 is a simplified side cross-section of a touch panel display constructed and arranged in accordance with an implementation of the invention;

FIG. 4 is a simplified side cross-section of a touch panel display constructed and arranged in accordance with an implementation of the invention;

FIG. 5 is a simplified side cross-section of a touch panel display constructed and arranged in accordance with an implementation of the invention;

FIG. 6 is a simplified side cross-section of a touch panel display constructed and arranged in accordance with an implementation of the invention, the display prior to being heated to an elevated temperature;

FIG. 7 is a simplified side cross-section of a touch panel display constructed and arranged in accordance with an implementation of the invention, the display after being heated to an elevated temperature;

FIG. 8 is a simplified side cross-section of a resistive touch panel constructed and arranged in accordance with an implementation of the invention; and

FIG. 9 is a simplified side cross-section of a four-wire resistive touch panel constructed and arranged in accordance with an implementation of the invention.

While the invention is amenable to various modifications and alternative forms, specifics thereof have been shown by way of example in the drawings and will be described in detail. It should be understood, however, that the intention is not to limit the invention to the particular described embodiments. On the contrary, the intention is to cover all modifications, equivalents, and alternatives falling within the spirit and scope of the invention.

### DETAILED DESCRIPTION

The present invention is directed, in part, to a printable composition for forming an insulating layer and methods of depositing the compositions. The printable composition is particularly well suited for making insulating masks on touch screens, but is also suitable for a variety of other applications. In certain embodiments the composition is suitable for deposit onto a substrate using ink jet printing technology to precisely apply the printable composition. In other embodiments the composition is suitable for deposit onto a substrate using other printing or patterning methods, such as screen printing. In addition, the present invention is directed to insulating layers made using the composition, as well as to methods of applying the composition and articles incorporating insulating and dielectric layers made using the composition.

More particularly the present invention provides a printable composition comprising a polyorganosilsesquioxane polymer and oxide particles dispersed in the polyorganosilsesquioxane. The printable composition is heat-curable to provide a cured insulating layer. The cured composition is particularly well suited to providing an insulating layer, but also can function as a protective layer and/or as a hard coat. Thus, in certain implementations the printed and cured composition functions to isolate (or insulate) conductive traces on a substrate. The cured composition can also serve, for example, to protect conductive traces and linearization patterns on various substrates, such as touch-panel displays.

The printable compositions may include highly dispersed nanoparticles, and these nanoparticles may be prepared using a method that includes surface treatment of the particles with surface modifying agents. Surface treatment can improve compatibility between the nanoparticles and the organosilsesquioxane dispersion phase. Surface treatment can also keep the particles from agglomerating, which can be beneficial for ink jet printing. In exemplary embodiments, the surface modifier can be a carboxylic acid, a carboxylic acid derivative, a silane, or mixtures thereof as well as other types or mixtures of dispersants. Carboxylic acid derivatives can include, but are not limited to, hexanoic acid or 2[-2-(2-methoxyethoxy)ethoxy]acetic acid, for example. Surface modifying silanes can include, but are not limited to, methyltriethoxysilane, methyltrimethoxysilane, isobutyltriethoxysilane, isobutyltrimethoxysilane, isooctyltriethoxysilane, isooctyltrimethoxysilane, or mixtures thereof, for example.

Particularly suitable nanocomposite coating dispersions according to the present invention of ink jet printing comprise dispersed oxide sol particles in an organosilsesquioxane composition that show little tendency towards thixotropy.

Nanoparticles suitable for use with the invention typically include particles of metals, oxides, nitrides, carbides, chlorides or the like. Suitable inorganic oxides include silicon oxide, zirconium oxide, aluminum oxide, and vanadium oxide and mixtures thereof. They may be selected for their physical, optical, or other properties of interest. For example, in situations where transparency is desirable, it may be preferred to choose nanoparticles that are transparent, have a refractive index that matches the matrix material, and/or are small enough that light scattering is minimized. They may be selected for their lack of absorption of ultraviolet radiation (in certain embodiments), to prepare nanocomposite coating dispersions according to the present invention.

One advantage of the use of oxide nanoparticles in the printable composition according to the present invention is improvement of the hardness and abrasion resistance of resulting cured coatings. Another advantage is the retention of transparency of cured coatings. Also, suitable selection of an inorganic oxide or oxide mixture allows control of the refractive index properties of printable insulating compositions depending upon the refractive index and concentration of nanoparticles in the dispersion. An increase of refractive index from that of the polyorganosilsesquioxane occurs with increasing concentration of a selected inorganic oxide that has a refractive index higher than the polyorganosilsesquioxane. Another approach to control refractive index variation retains a constant total concentration of an inorganic oxide mixture comprising two or more oxides differing in refractive index properties. Adjustment of the ratio of oxides causes change in the refractive index of the nanocomposite coating dispersion and cured coatings produced from the coating dispersion. Suitable oxide particles typically have a refractive index from about 1.0 to 3.0, more typically from 1.2 to about 2.7, and a particle size less than about 500 nanometers, often less than 250 nanometers, frequently less than 125 nanometers.

The printable compositions of the invention are particularly suitable for use on touch activated user input devices. In such implementations the user input device has a substrate plus an insulating layer deposited onto at least a portion the substrate, the insulating layer comprising polyorganosilsesquioxane, frequently polymethylsilsesquioxane. The insulating layer also typically includes inorganic nanoparticles. Suitable substrates include, for example, glass or PET, which may be coated with a conductive coating such a conductive oxides or polymers.

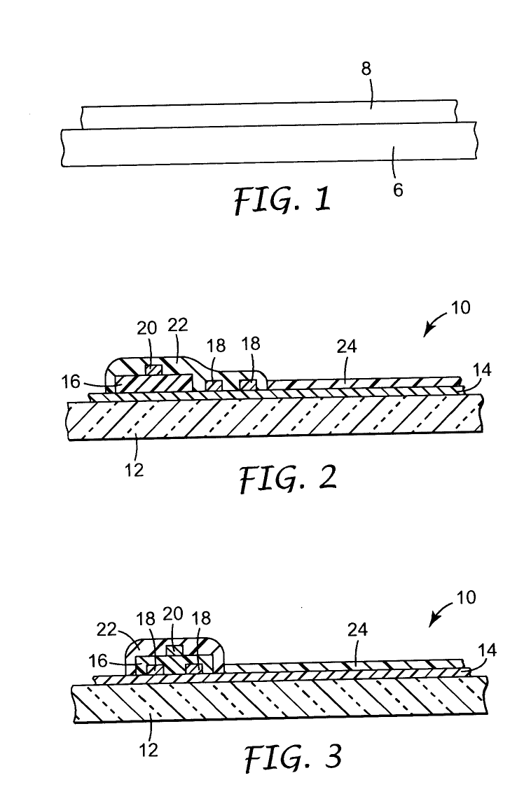

In reference now to FIG. 1, a simplified side cross-section of a substrate 6 containing an insulating layer 8 constructed and arranged in accordance with an implementation of the invention is shown. The substrate 6 can be, for example a glass, plastic, metal or other substrate that is non-conducting or conducting. The insulating layer 8 is a cured composition made in accordance with the present invention. In this simplified view only the insulating layer 8 and the substrate 6 are shown. However, it will be appreciated that in most implementations of the invention additional layers are likely, as discussed by example below.

Referring now to FIGS. 2 to 7, various example implementations of articles made in accordance with the present invention are shown. FIG. 2 shows a cross section of a capacitive touch screen 10 with a glass substrate 12 onto which a conductive layer 14 (such as indium tin oxide, tin antimony oxide, a conductive polymer, or another suitable transparent conductive oxide) has been deposited. An insulating layer 16 is deposited over a portion of the conductive layer 14, and an electrode pattern or linearization pattern 18 is also deposited onto the conductive layer 14. A wire trace 20 is deposited over the insulating layer 16. Finally, a protective layer 22 is deposited over the insulator, wire trace and electrode pattern, plus a hard coat layer 24 is deposited over the conductive layer.

The insulating layer 16, protective layer 22, and hard coat layer 24 can all be produced using the insulating composition of the invention. Alternately, only some of these layers are produced using the insulating composition of the invention. For example, the insulating layer 16 and protective layer 22 can be produced using the material of the invention ink jetted into place, while the hard coat 24 can be deposited by dip coating of the substrate. In some implementations one or more of these layers are deposited simultaneously or sequentially using similar or identical materials. For example, the protective layer 22 and the hard coat layer 24 can be deposited simultaneously or in sequence. It should also be appreciated that more or fewer layers of the insulating material can be deposited than shown in FIG. 2, and that the layers can be deposited in various thicknesses. In specific embodiments the protective layer 22 may be thicker than the insulating layer 16. In certain implementations the insulating layer 16 and protective layer 22 may be formed from the same material, although additional or separate steps may be required to build up the thicker protective layer 22.

Another embodiment of the invention is represented in FIG. 3. The various layers represented in FIG. 3 include a substrate 12, a conductive layer 14, insulating layer 16, and electrode or linearization pattern 18. A wire trace 20 is deposited on the insulating layer 16, and a protective layer 22 is positioned over the wire trace 20 and insulating layer 16. The protective layer 22 can cover all, or merely part, of the wire trace and insulating layer. Finally, a hard coat layer 24 is deposited over the top of the conductive layer 14. The embodiment depicted in FIG. 3 is similar to the embodiment shown in FIG. 2, but the electrode pattern or linearization pattern 18 is deposited before the insulating layer 16. In this embodiment the insulating layer 16 electrically isolates the wire trace 20 from the electrode pattern 18, allowing a narrower border around the electrode pattern.

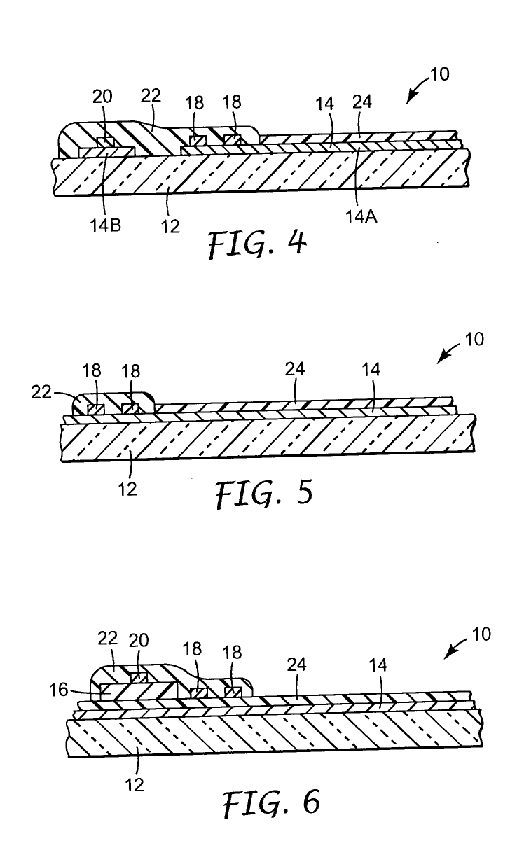

Yet another embodiment is depicted in FIG. 4, which has similar functionality to that shown in FIGS. 2 and 3, except the conductive layer 14 is discontinuous (having first portion 14A and second portion 14B, for example, been separated by laser ablation of a continuous conductive layer) so that an additional insulating layer is not required between the main conductive layer 14A and the wire trace 20.

A further embodiment is depicted in FIG. 5, showing a portion of a touch panel display without a wire trace (which could be positioned off to the side of the substrate). The touch panel includes a substrate 12, a conductive layer 14, plus an electrode or linearization pattern 18. Protective layer 22 and hard coat 24 are positioned over the electrode or linearization pattern 18 and the conductive layer 14. Again, protective layer 22, and hard coat layer 24 can all be produced using the insulating material of the invention. Alternately, only some of these layers are produced using the insulating material of the invention.

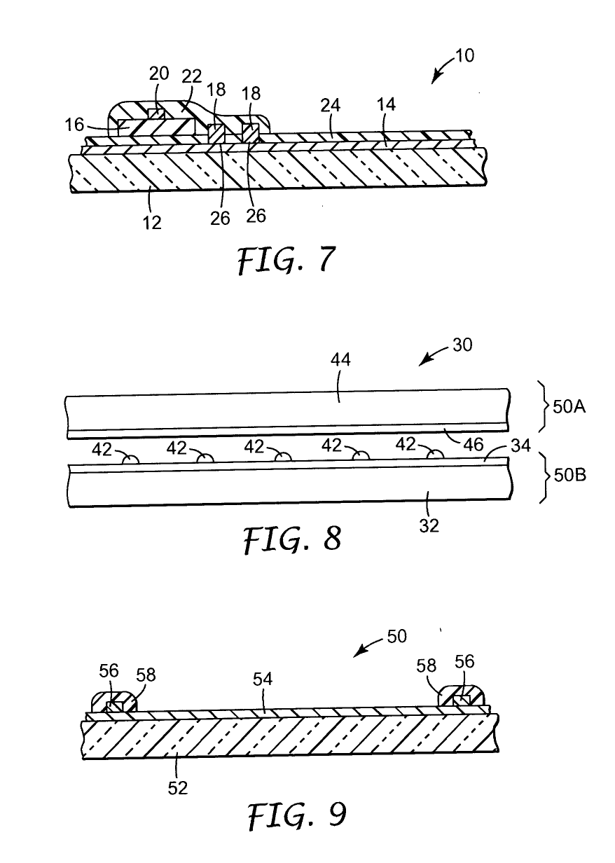

A further embodiment is depicted in FIGS. 6 and 7, this time depicting an implementation where the linearization pattern 18 is deposited over a portion of a hard coat layer 24 (which is also an insulating layer) that is deposited on top of a conductive layer 14 and subsequently heated to an elevated temperature to make an electric connection with the underlying conductive layer. FIG. 6 shows the coated substrate 10 prior to being heated to an elevated temperature, while FIG. 7 shows the coated substrate 10 after heating. During the heating process electrically conductive portions 26 form so as to create an electrical connection between the linearization pattern 18 and the conductive layer 14.

FIG. 8 shows a resistive touch panel 30 constructed and arranged in accordance with an implementation of the invention. The touch panel 30 includes a bottom substrate 32 onto which has been deposited a transparent conductor 34, such as a conductive oxide. Spacer dots 42 are positioned on top of the transparent conductor 34, these spacer dots serving to separate a top substrate 44, also containing a conductive layer 46, from the transparent conductor 34 and prevent unintentional contact between transparent conductor 34 and conductive layer 46. The spacer dots can be on the bottom substrate, top substrate, or both, but for simplicity and without loss of generality are shown just on the bottom substrate. As such, resistive touch panel 30 can be considered as comprising a top element 50A, which includes top substrate 44 and transparent conductor 46, and a bottom element 50B, which includes bottom substrate 32 and transparent conductor 34. Either or both of top element 50A or bottom element 50B can be constructed like the touch panels shown in FIGS. 2-7, excluding the hardcoat layers and optionally including spacer dots.

FIG. 9 shows a substrate element 50 useful as the top element 50A or bottom element 50B in cases where touch screen 30 is a four-wire resistive touch panel. In accordance with the invention, element 50 includes a substrate 52 and conductive layer 54. Wire traces 56 are found on two opposing edges of the substrate 52, and are covered with an insulating material 58 made in accordance with the present invention.

The present invention allows for the insulating layer to be precisely deposited without potentially damaging or contaminating the substrate, as can occur with screen printing. The insulating coating of the invention provides a further benefit in that it can be cured at relatively low temperatures, typically well below 200° C., and usually even well below 150° C.; yet the insulating material can withstand high temperatures (exceeding 520° C. in some embodiments). The ability to withstand these high temperatures can be important to implementations where higher temperatures are required in later processing steps, such as during the manufacture of touch screen displays. The low cure temperature makes the PSQ nanocomposite particularly interesting for use in touch screens in which the conductive layer is PEDOT or another conducting polymer, which will not withstand the extremely high temps (>500° C.) sometimes used to cure insulating layers on top of transparent conducting inorganic oxides. When the insulating coating is applied as a hardcoat over the entire touch-sensitive surface of the input device, it can be advantageous to cure the coating at a high temperature, to ensure the highest scratch resistance possible.

One method of printing the compositions of the invention is by ink jet printing. Ink jet printing of the composition can provide many advantages over conventional methods of applying insulating layers to a substrate. Ink jet printing is a non-contact printing method, thus allowing insulating materials to be printed directly onto substrates without damaging and/or contaminating the substrate surface due to contact, as may occur when using screens or masks and/or wet processing during conventional printing. Ink jet printing also provides a highly controllable printing method that can produce precise and consistently applied material. Controllable dimensions for the insulating layer are desirable for many applications, such as the use on touch panels so that physical properties of the touch panel can be selected.

Ink jet printing can also provide a higher degree of confidence that the surface has been properly printed. If it is determined that a portion of the surface has not been properly printed, then printing with ink jet allows the ability to go back and print skipped areas in the appropriate locations. In contrast, the screens used in screen printing can get clogged, resulting in incomplete mask coverage that is not readily repairable by screen printing. Alternatively, ink jet printing may be employed in conjunction with another printing technique, for example to repair or to fill in spots missed by an initial screen printing step.

Ink jet printing is also highly versatile in that printing patterns can be easily changed, whereas screen printing and other mask-based techniques require a different screen or mask to be used with each individual pattern. Thus, ink jet printing does not require a large inventory of screens or masks that need to be cleaned and maintained. Also, additional printable compositions can be ink jet printed onto previously formed insulating layers to create larger (e.g., taller) layers. Ink jet printing can also result in smaller printed dimensions than is practical from screen printing due to ink jet printing's much higher degree of controllability.

The printable composition typically has a viscosity making it amenable to digital printing techniques, for example ink jet printing, for coating or patterning onto a substrate. For ink jet printing, the composition may have a viscosity of 1 to 40 centipoise measured using continuous stress sweep over shear rates of 1 s⁻¹ to 1000 s⁻¹; and frequently a viscosity of 10 to 14 centipoise measured using continuous stress sweep, over shear rates of 1 s⁻¹ to 1000s⁻¹. Viscosities of 1 to 100,000 centipoise may be suitable for various other digital printing techniques, such as aerosol printing and syringe printing. Digital printing is a rapidly changing field, and it will be appreciated that the present invention contemplates the use of any suitable digital printing technique now known or later developed.

The printable composition is normally hardened after printing, for example by curing via radiation exposure, heat exposure, and the like. In many cases, it may be desirable to set the position and shape of the ink jet printed insulating material by cooling the insulating material from a less viscous state for printing to a more viscous state that maintains a size and shape.

Various additional aspects of the invention will now be described in greater detail.

### A. POLYMER CONTAINING SILICON AND OXYGEN

Compositions made in accordance with the invention contain a polymer of oxygen coordinated with silicon, typically in the form of a polysilsesquioxane. Polysilsesquioxanes have silicon coordinated with three bridging oxygen atoms in the form of [RSiO_{3/2}], and can form a wide variety of complex three-dimensional shapes. Various polysilsesquioxanes can be used, for example polymethylsilsesquioxane. Suitable specific polysilsesquioxanes include but are not limited to polymethylsilsesquioxane from Techneglas of Columbus, Ohio and sold under the label GR653L, GR654L, and GR650F. Additional suitable matrix polymers include organosilsesquioxanes, particularly methylsilsesquioxane resins, having a molecular weight from about 2,300 to about 15,000 as determined using gel permeation chromatography.

Generally, the printed and cured composition contains, for example, at least 10 percent by weight of a polysilsesquioxane, but can cover a range from 5 to 95 percent by weight polysilsesquioxane. As discussed above, this polysilsesquioxane is typically polymethylsilsesquioxane, but can be another polyorganosilsequioxane or a mixture of several.

### B. NANOPARTICLES

In certain embodiments of the invention the composition comprises nanometer sized particles, also referred to as nanoparticles, along with the polymer containing silicon and oxygen. Suitable nanoparticles include inorganic oxide particles such as silica; metal oxides such as alumina, tin oxide, antimony oxide, zirconia, vanadia, and titania; combinations of these; and the like.

Colloidal nanoparticles dispersed in an organosilsesquioxane fluid resin produced coatings that were less susceptible to shrinkage during cure than unfilled coating compositions. The more a coating shrinks during cure, the more likely it is to crack. Introduction of precondensed nanoparticulates into the silsesquioxane coating provides coatings having reduced shrinkage. Cracking or crazing of the insulating layer will allow for current to flow through the layer, producing electrical shorting in the touch screen. This reduced shrinkage also allows a coating to be applied as a thicker layer than can be done with other high-temperature cured sol-gel coatings, such as those based on TEOS, which can crack during cure if applied too thickly. Nanoparticles of oxides including silicon and zirconium oxides, having a refractive index from about 1.2 to about 2.7, may be dispersed in a liquid polymer matrix to provide nanocomposite coating dispersions according to the present invention comprising particles having an average particle size below about 500 nanometers (0.5 μm) preferably from about 5 nm to about 75 nm. An exemplary coating, comprises silica or zirconia nanoparticles dispersed in polymethylsilsesquioxane.

Although not wishing to be bound by theory, reduced shrinkage appears to occur because precondensed nanoparticles occupy some of the volume of a coating composition, reducing the amount of organosilsesquioxane that needs to cure, thereby reducing the shrinkage attributable to the dispersion phase. Additionally, the dispersed particles may act as “energy absorbers,” limiting the propagation or even the formation of micro-cracks. For this reason, coated dispersions exhibit dimensional stability and less of a tendency for cracks to form as the coating cures. The presence of nanoparticles also increases the durability and abrasion resistance of insulating coatings.

In the practice of the present invention, particle size may be determined using any suitable technique. Typically the printable composition used to form an insulating material comprises at least 1 percent nanoparticles, more typically greater than 3 percent nanoparticles, and even more typically greater than 5 percent nanoparticles. In some implementations the printed and cured composition comprises from 5 to 95 percent by weight of a polysilsesquioxane and from 5 to 95 percent by weight inorganic nanoparticles. It will be appreciated by those of skill in the art, that the range of compositions described in weight percentages are necessarily broad due to the difference in densities of different inorganic oxide nanoparticles compositions.

In general, a nanocomposite coating dispersion can be defined as a polymer matrix that contains well-dispersed nanoparticles. Optimum dispersion of the nanoparticles in a polymer matrix may depend upon surface treatment of the nanoparticles with surface modifying agents selected from carboxylic acids, silanes and dispersants. Suitable acidic surface modifiers include, but are not limited to, 2[-2-(2-methoxyethoxy)ethoxy]acetic acid and hexanoic acid. Silane surface modifiers include, but are not limited to, methyltriethoxysilane, isobutyltrimethoxysilane and isooctyltrimethoxysilane. Surface modification of inorganic particles can be carried out in water or in a mixture of water and one or more co-solvents depending on the particular surface treatment agent used, and may employ both basic and acidic inorganic oxide sols.

### C. OTHER INGREDIENTS

As stated above, the more a coating shrinks during cure, the more likely it is to crack. Introduction of precondensed nanoparticulates into the silsesquioxane coating provides coatings having reduced shrinkage. Optional additives to increase the flexibility to coatings according to the present invention include materials that may be added to coating formulations in small amounts from about 1 wt % to about 40 wt % or more of the printed and cured composition. Flexibilizers include reactive ingredients that upon curing are incorporated into the crosslinked silsesquioxane network and effectively increase the linear distance between crosslinks, thus decreasing the crosslink density. Flexibilizers include dialkyldialkoxysilanes and trialkylmonoalkoxysilanes such as dimethyldiethoxysilane, dimethyldimethoxysilane, trimethylethoxysilane, trimethylmethoxysilane, and the like.

Certain reactive ingredients such as tetraalkoxysilanes and alkyltrialkoxysilanes can be added to modify the physical properties of the cured coating, and may be used in conjunction with or in place of non-reactive solvent in the composition. Such ingredients may be present in an amount of about 0 to 50 weight percent. Examples include, but are not limited to, tetraethoxysilane, tetramethoxysilane, methytriethoxysilane, and methyltrimethoxysilane.

A variety of solvents can be suitably used in compositions of the present invention, including alcohols, ketones, ethers, acetates and the like. Exemplary solvents include methanol, ethanol, butanol, and 1-methoxy-2-propanol.

Optional additives to increase adhesion to substrate, or wetting agents to improve flow on a substrate, may be added to coating formulations in small amounts from about 0 wt % to about 10 wt % or more. An exemplary adhesion promoter is polyethyloxazoline.

Other optional ingredients can include organic acids, which can serve to catalyze the condensation reaction. Exemplary organic acids may include acetic acid, methoxyethoxyacetic acid, or hexanoic acid. The organic acid may preferably be present in an amount of 0 to 3 percent by weight of the composition after evaporation of substantially all the solvent.

### D. METHODS

The present invention also provides a method of ink jet printing materials onto a substrate element that includes a conductive coating so that the ink jet printed materials can be hardened to form insulating materials suitable for use in touch panels. Various factors may affect whether and to what degree the ink jet printed materials may be suited for forming insulating materials. As discussed above, the optical properties of the ink jet printed material can be important. For example, if the materials scatter visible light, the insulating materials used as a hard coat over the entire touch screen may be conspicuous to a user and may detract from viewing quality on touch panel applications. Alternatively, controlled light scattering may be useful to provide anti-glare properties. Further, it may be desirable to print insulating materials that exhibit relatively little spreading after printing.

The invention is further directed to a method for making a touch activated user input device comprising providing a substrate, printing a composition containing polymethylsilsesquioxane onto the substrate, and curing the composition containing polymethylsilsesquioxane at a temperature below 150° C. to form an insulating layer. In some implementations the step of printing comprises ink jet printing, while in others the step of printing comprises screen-printing.

### E. EXAMPLES

The invention will now be explained in additional detail by reference to the following examples.

### Example 1

For this example polysilsesquioxanes with zirconia nanoparticles were ink jet printed onto a substrate containing screen printed conductive traces.

Polysilsesquioxanes for the printing composition were formulated as follows. Composition 1A was prepared by mixing 23 grams of Nalco Zirconia sol 00SSOO8 (Nalco Chemical Company, Bedford Park, Ill.) with 0.97 grams 2-[2-(2-methoxyethoxy)ethoxy]acetic acid (Aldrich Chemical Company, Inc., Milwaukee, Wis.) to form a homogenous sol. This sol was added with mixing to 100 grams of polymethylsilsesquioxane in butanol (GR653L, Techneglas, Columbus, Ohio). The mixture was filtered through a Gelman Glass Acrodisc (1 micron glass fiber membrane) 25 mm syringe filter.

Composition 1B was prepared by mixing 48 grams of Nalco Zirconia sol 00SSOO8 (Nalco Chemical Company, Bedford Park, Ill.) with 2.0 grams of 2-[2-(2-methoxyethoxy)ethoxy]acetic acid (Aldrich Chemical Company, Inc., Milwaukee, Wis.) to form a homogenous sol. This sol was added with mixing to a mixture of 100 grams polymethylsilsesquioxane in butanol (GR653L, Techneglas, Columbus, Ohio) and 5.0 grams dimethyldiethoxysilane (Aldrich Chemical Company, Inc., Milwaukee, Wis.). The mixture was filtered through a Gelman Glass Acrodisc (1 micron glass fiber membrane) 25 mm syringe filter.

Composition 1C was prepared by mixing 67.2 grams of Nalco Zirconia sol 00SSOO8 (Nalco Chemical Company, Bedford Park, Ill.) with 2.8 grams 2-[2-(2-methoxyethoxy)ethoxy]acetic acid (Aldrich Chemical Company, Inc., Milwaukee, Wis.) to form a homogenous sol. This sol was added with mixing to a mixture of 140 grams polymethylsilsesquioxane in butanol (GR653L, Techneglas, Columbus, Ohio) and 7.0 grams carbinolmethylsiloxane-dimethylsilicone copolymer (Gelest Inc., Tullytown, Pa.). The mixture was filtered through a Gelman Glass Acrodisc (1 micron glass fiber membrane) 25 mm syringe filter.

Rheology of each composition was measured on a Bohlin Instruments CVO High Resolution Rheometer, using a C25 cup. Viscosity of these compositions at a shear rate of 1 s⁻¹ were as follows. Composition 1A: 11.4 cP, composition 1B: 10.6 cP, composition 1C: 11 cP.

Each of these three compositions were ink jet printed onto screen printed conductive traces on glass, using a Xaarjet 128 70 pL printhead at 35 volts. Each pattern was jet printed three times, then placed in a 130° C. oven for 15 minutes. The samples produced distinct vias, produced to demonstrate the ability to precisely print complex structures. The vias were produced with no pinholes visible under a microscope. The edges of the vias were scalloped. The material insulated the conductive traces beneath it, and the insulating layer was clear. Sample heights were measured on Wyko Interferometer optical profiler. The thickness of the screen printed conductive traces was about the same as the thickness of the dielectric mask. The dielectric mask thickness was about 10 microns, while the conductive trace thickness is about 10 to 14 μm.

### Example 2

For this example polysilsesquioxanes were ink jet printed for use as a hardcoat.

Composition 2A was prepared by mixing 23 grams of Nalco Zirconia sol 00SSOO8 (Nalco Chemical Company, Bedford Park, Ill.) with 0.97 grams 2-[2-(2-methoxyethoxy)ethoxy]acetic acid (Aldrich Chemical Company, Inc., Milwaukee, Wis.) to form a homogenous sol. This sol was added with mixing to 100 grams of polymethylsilsesquioxane in butanol (GR653L, Techneglas, Columbus, Ohio). The mixture was filtered through a Gelman Glass Acrodisc (1 micron glass fiber membrane) 25 mm syringe filter. The solution was ink jet printed onto Indium Tin Oxide coated PET in a 3 inch by 3 inch square, using a Xaarjet 128 70 pL printhead at 35 volts. The pattern was jet printed three times, then placed in a 130° C. oven for 15 minutes.

The sample was subsequently abraded using a Delrin stylus tip with a ⅛ inch radius, for 20,000 cycles with a 650 g weight. Following abrasion, the side coated with polysilsesquioxane showed no scratching, while the non-coated side (indium tin oxide only) showed significant scratching.

UV-Visible spectral analysis was measured on each sample. Measurements were made on a Perkin Elmer Lambda 900 Spectrophotometer fitted with a PELA-1000 integrating sphere accessory. This sphere is 150 mm (6 inches) in diameter and complies with ASTM methods E903, D1003, E308, et al. as published in “ASTM Standards on Color and Appearance Measurement,” Third Edition, ASTM, 1991. Total Luminous Transmission (TLT) and Diffuse Luminous Transmission (DLT) were measured over the spectral range of 200-850 nm.

Haze was calculated as follows over the range 380-780 nm. Both the substrate material and hardcoat were analyzed in duplicate.
Haze=100(Tt/Td*w)
Tt=total luminous transmission
Td=total diffuse transmission (corrected)
w=CIE C weighting factors

Both TLT and DLT increased for the coated area with a minimal increase in haze, as shown in Table 1 below.

TABLE 1

| Sample | Tt | Td | % Haze |
|---|---|---|---|
| Substrate only | | | |
| area 1 | 78.7% | 2.5% | 3.1% |
| area 2 | 79.2% | 2.5% | 3.2% |
| Hardcoat on Substrate | | | |
| area 1 | 84.1% | 3.0% | 3.6% |
| area 2 | 84.3% | 3.0% | 3.6% |

### Example 3

This example tested ink jet printing of polysilsesquioxanes with silica nanoparticles.

First, methyltriethoxysilane treated NALCO 2327 20 nm silica particles were prepared. To a 1 liter reaction vessel equipped with a stir bar was added 125.0 g of NALCO 2327 (41.45% aqueous dispersion of 20 nm silica particles in water. To the stirring sol was slowly added over 30 minutes 5.7277 g of methyltriethoxysilane (MTEOS) (0.62 mmol silane/g of silica) in 143.75 g of 1-methoxy-2-propanol. The sealed reaction vessel was placed into a 90° C. oven for 20 hours. The reaction vessel was removed from the oven and the water was removed as an azeotrope with methoxy propanol in vacuo to leave a solution of methyltriethoxy silane treated NALCO 2327 particles in 1-methoxy-2-propanol. The solution was then filtered through a coarse filter to remove particulate matter and the solution was determined to be 22.3% MTEOS-2327 in 1-methoxy-2-propanol by gravimetric analysis.

Next, in a separate container, Techneglas GR-650F polymethylsiloxane in butanol was prepared. To a 1 liter glass jar was added 214.72 g of Techneglas GR-650F glass resin (lot #55830) along with 501 g of butanol (Aldrich). The solution was stirred using an overhead stirrer for 6 hours to give a homogeneous solution of GR650F in butanol. The solution was 30% by weight GR-650F in butanol.

MTEOS-2327 filled GR650F resin for Ink Jet: To a large vial was added 17.0 g of the 30% Techneglas GR-650F resin in butanol and 10.0 g of the 22.3% MTEOS-2327 particles in 1-methoxy-2-propanol. The vial was sealed and mixed by shaking to give homogeneous solution with a slight bluish tint. A catalyst consisting of 1 part ammonium hydroxide (25% in methanol) and 2 parts formic acid was added and mixed into the solution at 3 wt % (0.1530 g).

Rheology of this solution was measured on a Bohlin Instruments CVO High Resolution Rheometer, using the C25 cup. Viscosity of this solution at shear rate of 1 s⁻¹ was 12 cP. This solution was inkjet printed onto glass, using a Xaarjet 128 70 pL printhead at 35 volts. The sample was placed in a 130° C. oven for 15 minutes. This produced a hard, continuous film.

### Example 4

In this example, mq resins were ink jet printed.

A polysilsesquioxane formulation was prepared as follows: 35% wt SR 1000 mq resin polytrimethyl hydrosilylsilicate from GE Silicones (Waterford, N.Y.) was mixed into 65 wt % butanol from Aldrich Chemical Co. (Milwaukee, Wis.) using a magnet stir rod for 20 minutes. Rheology of this solution was measured on a Bohlin Instruments CVO High Resolution Rheometer, using the C25 cup. Viscosity of this solution at shear rate of 1 s⁻¹ was 8.2 cP.

This solution was ink jet printed onto glass, using a Xaarjet 128 70 pL printhead at 35 volts. The sample was placed in a 130° C. oven for 1 hour. This produced a hard, continuous film.

### Example 5

Pigmented polysilsesquioxanes for high temperature resistant bar coding were produced for this example.

Composition 5A was prepared by mixing 23 grams of Nalco Zirconia sol 00SSOO8 (Nalco Chemical Company, Bedford Park, Ill.) with 0.97 grams 2-[2-(2-methoxyethoxy)ethoxy]acetic acid (Aldrich Chemical Company, Inc., Milwaukee, Wis.) to form a homogenous sol. This sol was added with mixing to 100 grams of polymethylsilsesquioxane in butanol (GR653L, Techneglas, Columbus, Ohio). The mixture was filtered through a Gelman Glass Acrodisc (1 micron glass fiber membrane) 25 mm syringe filter. To this formulation, 8 g butanol and 1.526 g Ciba Microlith C-A Black pigment were added.

The sample was placed on a roller and rolled for 15 hours. The sample appeared well dispersed, no settling was apparent after 15 days. Rheology of this solution was measured on the Bohlin Instruments CVO High Resolution Rheometer, using the C25 cup and bob geometry. Viscosity of this solution at shear rate of 1 s⁻¹ was 15.0 cP. This solution was ink jet printed onto glass, using a Xaarjet 128 70 pL printhead at 35 volts. The sample was placed in a 130° C. oven for 15 minutes. This produced a cured, high temperature resistant bar code pattern.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

Each of the patents, patent documents, and publications cited above is hereby incorporated into this document as if reproduced in full.

1. A composition for forming an insulating layer, the composition comprising:
a mixture comprising inorganic nanoparticles present in an amount of 5 to 95 percent by weight of the mixture dispersed in polymethylsilsesquioxane present in an amount of 5 to 95 percent by weight of the mixture;
a solvent; and
one or more optional additives,
wherein the composition has a viscosity suitable for applying the composition using a digital printing technique.

2. The composition of claim 1, wherein the composition has a viscosity of 1 to 100,000 centipoise measured using continuous stress sweep, over shear rates of 1 s⁻¹ to 1000 s⁻¹.

3. The composition of claim 1, wherein the composition has a viscosity suitable for ink jet printing.

4. The composition of claim 3, wherein the composition has a viscosity of 1 to 40 centipoise measured using continuous stress sweep, over shear rates of 1 s⁻¹ to 1000 s⁻¹.

5. The composition of claim 1, wherein the nanoparticles comprise one or more of silica, zirconia, and alumina particles.

6. The composition of claim 1, wherein the inorganic nanoparticles are surface modified.

7. The composition of claim 6, wherein the surface modifier comprises a carboxylic acid, a carboxylic acid derivative, a silane, or mixtures thereof.

8. The composition of claim 7, wherein the carboxylic acid derivatives comprise hexanoic acid or 2[-2-(2-methoxyethoxy)ethoxy]acetic acid.

9. The composition of claim 7, wherein the silanes comprise methyltriethoxysilane, methyltrimethoxysilane, isobutyltriethoxysilane, isobutyltrimethoxysilane, isooctyltriethoxysilane, isooctyltrimethoxysilane, or mixtures thereof.

10. The composition of claim 1, wherein the nanoparticles have an average size of 1 to 500 nanometers.

11. The composition of claim 1, wherein the nanoparticles have an average size of 5 to 125 nanometers.

12. The composition of claim 1, wherein the one or more optional additives are present in an amount of 0 to 60 percent by weight of the composition after evaporation of substantially all the solvent.

13. The composition of claim 1, wherein the one or more optional additives comprise an adhesion promoter.

14. The composition of claim 13, wherein the adhesion promoter comprises polyethyloxazoline.

15. The composition of claim 13, wherein the adhesion promoter is present in an amount of 0 to 5 percent by weight of the composition after evaporation of substantially all the solvent.

16. The composition of claim 1, wherein the one or more optional additives comprise one or more tetraalkoxysilanes and alkyltrialkoxysilanes.

17. The composition of claim 16, wherein the alkoxysilanes are selected from the group consisting essentially of tetraethoxysilane, tetramethoxysilane, methytriethoxysilane, and methyltrimethoxysilane.

18. The composition of claim 16, wherein the one or more tetraalkoxysilanes and alkyltrialkoxysilanes are present in an amount of 0 to 50 percent by weight of the composition after evaporation of substantially all the solvent.

19. The composition of claim 1, wherein the one or more optional additives comprise a flexibilizer.

20. The composition of claim 19, wherein the flexibilizer comprises one or more of dialkyldialkoxysilanes and trialkylmonoalkoxysilanes.

21. The composition of claim 20, wherein the one or more dialkyldialkoxysilanes and trialkylmonoalkoxysilanes are selected from the group consisting essentially of dimethyldiethoxysilane, dimethyldimethoxysilane, trimethylethoxysilane, and trimethylmethoxysilane.

22. The composition of claim 19, wherein the flexibilizer is present in an amount of 0 to 40 percent by weight of the composition after evaporation of substantially all the solvent.

23. The composition of claim 1, wherein the one or more optional additives comprise an organic acid.

24. The composition of claim 23, wherein the organic acid comprises acetic acid, methoxyethoxyacetic acid, hexanoic acid, or mixtures thereof.

25. The composition of claim 23, wherein the organic acid is present in an amount of 0 to 3 percent by weight of the composition after evaporation of substantially all the solvent.

26. The composition of claim 1, wherein the solvent comprises an alcohol, a ketone, an ether, an acetate, or mixtures thereof.

27. A method of printing an insulating layer comprising:
providing a composition for forming an insulating layer, the composition comprising (i) a mixture comprising surface modified inorganic nanoparticles present in an amount of 5 to 95 percent by weight of the mixture dispersed in polymethylsilsesquioxane present in an amount of 5 to 95 percent by weight of the mixture, (ii) a solvent, and (iii) one or more optional additives; and
printing the composition onto a substrate using a digital printing technique.

28. The method of claim 27, wherein the digital printing technique comprises ink jet printing.

29. The method of claim 27, wherein the digital printing technique comprises aerosol printing or syringe printing.

30. The method of claim 27, further comprising the step of drying the composition after the printing step to substantially remove the solvent.

31. The method of claim 27, further comprising incorporating the substrate into a touch activated user input device.

32. A touch activated user input device comprising:
a substrate; and
an insulating layer deposited onto at least a portion of the substrate, the insulating layer comprising polyorganosilsesquioxane.

33. The touch activated user input device of claim 32, wherein the insulating layer further comprises inorganic nanoparticles.

34. The touch activated user input device of claim 32, wherein the substrate comprises glass or plastic.

35. The touch activated user input device of claim 32, wherein the plastic substrate comprises polyethylene terephthalate.

36. The touch activated user input device of claim 32, wherein the substrate comprises conductive traces on a non-conductive surface.

37. The touch activated user input device of claim 32, wherein the insulating layer is deposited as a protective coat over conductive traces.

38. The touch activated user input device of claim 32, wherein the insulating layer is deposited as a protective coat over a linearization layer.

39. The touch activated user input device of claim 32, wherein the substrate has a primary surface, and wherein the insulating layer is deposited as a hard coat over a majority of the primary surface.

40. The touch activated user input device of claim 36, wherein the conductive traces comprise a conductive polymer.

41. The touch activated user input device of claim 36, wherein the insulating layer at least partially covers the conductive traces and wherein the insulating composition is substantially free of pinholes.

42. The touch activated user input device of claim 32, wherein the insulating layer is a protective coating over a resistive layer disposed in an active area of the touch device for carrying a signal indicative of a touch input.

43. The touch activated user input device of claim 32, wherein the insulating layer comprises at least 10 percent by weight polymethylsilsesquioxane.

44. The touch activated user input device of claim 32, wherein the insulating layer comprises from 10 to 95 percent by weight polymethylsilsesquioxane and from 5 to 90 percent by weight inorganic nanoparticles.

45. The touch activated user input device of claim 32, wherein the insulating layer is substantially stable at a temperature of 500° C.

46. A method for making a touch activated user input device comprising:
providing a substrate;
printing a composition containing polyorganosilsesquioxane onto the substrate;
curing the composition containing polyorganosilsesquioxane at a temperature below 150° C. to form an insulating layer.

47. The method of claim 46, wherein the step of printing comprises ink jet printing.

48. The method of claim 46, wherein the step of printing comprises screen printing.

49. The method of claim 46, wherein the insulating layer is substantially stable at a temperature of 500° C.

50. The method of claim 46, wherein the composition containing polymethylsilsesquioxane further comprises inorganic nanoparticles.

51. The method of claim 50, wherein the inorganic nanoparticles comprise one or more of silica, zirconia, and alumina particles.

52. The method of claim 50, wherein the nanoparticles are surface-modified.

53. The method of claim 46, wherein the composition containing polymethylsilsesquioxane comprises at least 10 percent by weight polymethylsilsesquioxane.

54. The method of claim 46, wherein after the curing step the composition comprises from 10 to 95 percent by weight polymethylsilsesquioxane and from 5 to 90 percent by weight inorganic nanoparticles.
